(19) United States
(12) Patent Application Publication
(10) Pub. No.: US 2025/0250913 A1
(43) Pub. Date: Aug. 7, 2025

(54) SYSTEM AND METHOD FOR ASSEMBLING A FAN CASE OF A GAS TURBINE ENGINE

(71) Applicant: ROLLS-ROYCE plc, London (GB)

(72) Inventor: Marius MONORANU, Derby (GB)

(73) Assignee: ROLLS-ROYCE plc, London (GB)

(21) Appl. No.: 19/033,667

(22) Filed: Jan. 22, 2025

(30) Foreign Application Priority Data
Feb. 7, 2024 (GB) 2401612.3

(51) Int. Cl. F01D 25/24

(52) U.S. Cl. CPC F01D 25/24; F05D 2220/32; F05D 2230/23; F05D 2240/14

(57) ABSTRACT

A system for assembling a fan case of a gas turbine engine includes at least one adhesive layer disposed on an inner surface of a fan case barrel, at least one liner disposed on the inwardly-facing surface of the at least one adhesive layer, an annular structure adapted to be disposed on an outer surface of the fan case barrel, and a heat source coupled to the annular structure to heat the annular structure to at least a predetermined curing temperature, such that the annular structure inductively heats the at least one adhesive layer. Upon being inductively heated by the annular structure, the at least one adhesive layer is cured, thereby adhesively bonding the at least one liner to the inner surface of the fan case barrel.

### CROSS-REFERENCE TO RELATED APPLICATIONS

This specification is based upon and claims the benefit of priority from United Kingdom patent application number GB 2401612.3 filed on Feb. 7, 2024, the entire contents of which is incorporated herein by reference.

### BACKGROUND

### Technical Field

The present disclosure relates to a gas turbine engine, and in particular, to a system and a method for assembling a fan case of the gas turbine engine.

### Description of the Related Art

Generally, a gas turbine engine includes a fan assembly to push air through the gas turbine engine and provide thrust for an application, such as, an aircraft. The fan assembly typically includes a fan rotor, a plurality of fan blades coupled to the fan rotor, and a fan case that extends around the plurality of fan blades. In some examples, one or more fan blades may detach from the fan rotor in case of a blade-off event while the gas turbine engine is operating. The detached fan blades may contact an inner surface of the fan case and may damage the fan case, which is not desirable. In other examples, foreign objects, e.g., ice or birds may be accidentally drawn into the gas turbine engine and may come in contact with the inner surface of the fan case. Damage caused to the fan case or the gas turbine engine by such impacts can decrease an operational efficiency of the gas turbine engine and in some instances cause safety issues, which is not desirable. Therefore, the fan assembly includes a number of impact liners that are coupled at the inner surface of the fan case to prevent damage to the fan case.

Conventionally, pre-manufactured impact liners are attached to the inner surface of the fan case using a corresponding film adhesive. The fan assembly including the liners, the adhesive films, and the fan case is then cured under vacuum conditions, for example, in an autoclave or in an oven. However, due to a large size of the fan assembly, a cure ramp rate requirement for the film adhesives may not be achieved, which may negatively impact a quality and a durability of the impact liners. Overall, conventional techniques of curing the adhesive film may cause non-compliance with design requirements of the impact liner by not adequately meeting material cure requirements. Further, heating of the entire fan case in the autoclave or the oven for curing the film adhesive may require higher energy consumption and longer curing time, which may in turn increase costs associated with manufacturing the fan assembly.

### SUMMARY

In a first aspect, there is provided a system for assembling a fan case of a gas turbine engine. The system includes at least one adhesive layer disposed on an inner surface of a fan case barrel of the fan case. The at least one adhesive layer includes an inwardly-facing surface that is radially spaced apart from the inner surface of the fan case barrel. The system further includes at least one liner disposed on the inwardly-facing surface of the at least one adhesive layer. The system further includes an annular structure adapted to be disposed on an outer surface of the fan case barrel. The system further includes a heat source coupled to the annular structure. The heat source is adapted to heat the annular structure to at least a predetermined curing temperature, such that the annular structure inductively heats the at least one adhesive layer. Upon being inductively heated by the annular structure, the at least one adhesive layer is cured, thereby adhesively bonding the at least one liner to the inner surface of the fan case barrel.

The system further includes a controller that is communicably coupled to the heat source. The controller is configured to control the heat source to heat the annular structure to at least the predetermined curing temperature. The system further includes at least one temperature sensor that is disposed proximal to the inner surface of the fan case barrel to measure a temperature proximal to the inner surface of the fan case barrel. The at least one temperature sensor is communicably coupled to the controller. The controller is configured to control the heat source, so that the temperature proximal to the inner surface of the fan case barrel is equal to at least the predetermined curing temperature.

The system of the present disclosure uses the heat source that is coupled to the annular structure to heat and cure the adhesive layer in order to adhesively bond the at least one liner to the inner surface of the fan case barrel. Incorporation of the heat source may eliminate the requirement of heating the entire fan case barrel to cure the adhesive layer, which may reduce manufacturing costs as compared to a conventional autoclave/oven curing solution.

Further, the system may provide faster curing cycles by heating and subsequently curing the adhesive layer. The system may utilize lower energy consumption for curing the adhesive layer, thereby providing a cost-effective and a sustainable assembly solution. The system may further enable the adhesive layer to achieve a desired cure ramp rate to meet desired material specification requirements.

Further, the liner disposed on the fan case barrel may prevent damage to the fan case and the gas turbine engine by absorbing an energy of impact in an event of detachment of fan blade(s) during operation of the gas turbine engine or due to impact with foreign objects, e.g., ice or birds, that may be accidentally drawn into the gas turbine engine. Thus, the liner may improve a safety of the gas turbine engine and may maintain an operational efficiency of the gas turbine engine. The liners bonded using the system may exhibit improved quality and durability.

Controlling the heat source may prevent overheating of the annular structure by the heat source, thereby preventing any damage to the annular structure. Further, controlling of the heat source may also enable the adhesive layer to achieve the desired cure ramp rate in order to meet the desired material specification requirements.

The at least one temperature sensor may measure the temperature proximal to the inner surface of the fan case barrel and may communicate a value of the temperature to the controller. Further, based on the value of the temperature received form the temperature sensor, the controller may control the heat source so that the fan case barrel may attain at least the predetermined curing temperature, without overheating or causing damage to the liner, the fan case barrel, and/or the adhesive layer.

In some embodiments, the system further includes an insulation layer covering each of the at least one liner and the at least one adhesive layer. The insulation layer may minimize heat dissipation and may retain at least the predetermined curing temperature localized at the adhesive layer. Moreover, the insulation layer may also prevent damage to the fan case and the liner due to overheating.

In some embodiments, the at least one adhesive layer includes a plurality of adhesive layers that are circumferentially spaced apart from each other. The at least one liner includes a plurality of liners corresponding to the plurality of adhesive layers. The plurality of liners is circumferentially spaced apart from each other. Each of the plurality of liners is disposed on the inwardly-facing surface of a corresponding adhesive layer from the plurality of adhesive layers. Each of the plurality of liners is adhesively bonded to the inner surface of the fan case barrel by the corresponding adhesive layer.

Thus, each of the plurality of liners may be adhesively bonded to the inner surface of the fan case barrel and are circumferentially spaced apart from each other. This may ensure that the each of the plurality of liners is intact in position with respect to the corresponding adhesive layer while the gas turbine engine is operating at extreme conditions, such as high operating temperatures, without compromising the operational efficiency of the gas turbine engine. The plurality of liners adhesively bonded at the inner surface of the fan case barrel may prevent damage to the fan case barrel by absorbing the energy of impact in examples wherein one or more fan blades of the gas turbine engine detaches from a fan rotor in case of a blade-off event or during impact of the fan case barrel with foreign objects. The liners may also be designed to protect the fan case and the gas turbine engine from an impact of any foreign objects that may be accidentally drawn into the gas turbine engine.

The system may enable the adhesive layer to achieve the desired cure ramp rate which may improve an adhesive bond between the adhesive layer and the corresponding liner. Further, as the desired cure ramp rate is achieved, an adhesive bond between the adhesive layer and the inner surface of the fan case barrel may also be improved. Furthermore, the at least adhesive layer cured by the system may be of high quality, and may be compliant with profile tolerances, surface tolerances, adhesive thickness, and porosity requirements. In some embodiments, the adhesive layer may have a uniform thickness.

In some embodiments, the annular structure includes a composite material or a metallic material. The annular structure including the composite material or the metallic material may allow sufficient inductive heating of the adhesive layer to achieve at least the predetermined curing temperature for curing the adhesive layer.

In some embodiments, the heat source is at least partially embedded within the annular structure. This may enable the heat source to heat only the desired area of the fan case barrel instead of heating the entire fan case, thereby enabling lower energy consumption, and providing a sustainable assembly solution. Moreover, providing heat to only the desired area of the fan case barrel by the heat source may provide a stand-alone curing solution that may eliminate use of the conventional autoclave/oven curing solution to cure the adhesive layer. Further, the heat source may also provide a portable solution for service and maintenance during replacement of the liner.

In some embodiments, the heat source includes an electric cartridge, a heated fabric, a heated film, a ceramic heater, an induction heater, or a heated fluid. This may enable the heat source to heat only the desired area of the fan case barrel instead of heating the entire fan case, thereby preventing high energy consumption. The heat source may provide a stand-alone curing solution that 15 may eliminate use of the conventional autoclave/oven curing solution. Further, the heat source may provide a portable solution for service and maintenance during replacement of the liner.

In some embodiments, the at least one liner is made of a metal, a composite material, or a combination thereof. The liner made of a metal, a composite material, or a combination of both may absorb the energy of impact in case of the blade-off event or during impact with foreign objects and may maintain a structural integrity of the fan case. The material of the liner may also be chosen so as to withstand extreme operating conditions (e.g., high operating temperatures) of the gas turbine engine.

In some embodiments, the metal of the at least one liner is made of titanium, aluminium, or a combination thereof. The liner may absorb the energy of the impact of a separated portion or a complete fan blade in case of the blade-off event or during impact with foreign objects and may maintain the structural integrity of the fan case. The liner may also withstand extreme operating conditions (e.g., high operating temperatures) of the gas turbine engine.

In some embodiments, the at least one adhesive layer includes a structural adhesive film. The structural adhesive film may improve adhesive bond between the liner and the fan case barrel, thereby improving a service life, durability, and a functionality of the liner.

In a second aspect, there is provided a method for assembling a fan case of a gas turbine engine. The method includes disposing an annular structure on an outer surface of a fan case barrel of the fan case. The method further includes coupling a heat source to the annular structure. The method further includes disposing at least one adhesive layer on an inner surface of the fan case barrel. The method further includes heating, via the heat source, the annular structure to at least a predetermined curing temperature, such that the annular structure inductively heats the at least one adhesive layer. The method further includes controlling, via a controller that is communicably coupled to the heat source, the heat source to heat the annular structure to at least the predetermined curing temperature. The method further includes measuring, via at least one temperature sensor disposed proximal to the inner surface of the fan case barrel, a temperature proximal to the inner surface of the fan case barrel. The at least one temperature sensor is communicably coupled to the controller. The method further includes controlling, via the controller, the heat source, so that the temperature proximal to the inner surface of the fan case barrel is equal to at least the predetermined curing temperature. The method further includes curing the at least one adhesive layer due to the inductive heating of the at least one adhesive layer by the annular structure. The method further includes adhesively bonding the at least one liner to the inner surface of the fan case barrel upon curing of the at least one adhesive layer.

The method of the present disclosure may provide an improved approach for coupling the liner to the fan case barrel. Specifically, the method uses the heat source coupled to the annular structure to heat and cure the adhesive layer in order to adhesively bond the at least one liner to the inner surface of the fan case barrel. Thus, the method may eliminate a requirement of heating the entire fan case barrel to cure the adhesive layer, which may reduce manufacturing costs as compared to a conventional autoclave/oven curing solution.

Further, the method may provide faster curing cycles by heating and subsequently curing the adhesive layer. The method may enable low energy consumption for curing the adhesive layer, thereby providing a cost-effective and a sustainable assembly method. The method may further enable the adhesive layer to achieve a desired cure ramp rate for the adhesive layer to meet desired material specification requirements.

Further, the liner disposed on the fan case barrel may prevent damage to the fan case and the gas turbine engine by absorbing the energy of impact in an event of detachment of fan blade(s) or due to impact with foreign objects that may be accidentally drawn into the gas turbine engine, e.g., ice or birds. Thus, the method may improve a safety of the gas turbine engine and may maintain an operational efficiency of the gas turbine engine. The liners bonded using the method may exhibit improved quality and durability.

The controller is communicably coupled to the heat source and configured to control the heat source so that the annular structure may attain at least the predetermined curing temperature. Controlling of the heat source may prevent overheating of the annular structure by the heat source, thereby preventing any damage to the annular structure. Further, controlling of the heat source may also enable the adhesive layer to achieve the desired cure ramp rate to meet the desired material specification requirements.

The at least one temperature sensor may measure a temperature proximal to the inner surface of the fan case barrel and may communicate a value of the temperature to the controller. Further, based on the value of the temperature received form the temperature sensor, the controller may control the heat source so that the fan case barrel may attain at least the predetermined curing temperature, without overheating or causing damage to the liner, the fan case barrel, and/or the adhesive layer.

In some embodiments, the method further includes disposing an insulation layer covering each of the at least one liner and the at least one adhesive layer.

The insulation layer may minimize heat dissipation and may retain at least the predetermined curing temperature localized at the adhesive layer. Moreover, the insulation layer may also prevent damage to the fan case and the liner due to overheating.

In some embodiments, the at least one adhesive layer includes a plurality of adhesive layers that are circumferentially spaced apart from each other. The at least one liner includes a plurality of liners corresponding to the plurality of adhesive layers. The plurality of liners are circumferentially spaced apart from each other. The step of disposing the at least one liner on the inwardly-facing surface of the at least one adhesive layer further includes disposing each of the plurality of liners on the inwardly-facing surface of a corresponding adhesive layer from the plurality of adhesive layers.

Thus, each of the plurality of liners may be adhesively bonded to the inner surface of the fan case barrel and are circumferentially spaced apart from each other. This may ensure that the each of the plurality of liners is intact in position with respect to the corresponding adhesive layer while the gas turbine engine is operating at extreme conditions, such as high operating temperatures, without compromising the operational efficiency of the gas turbine engine. The plurality of liners adhesively bonded at the inner surface of the fan case barrel may prevent damage to the fan case barrel in examples wherein one or more fan blades of the gas turbine engine detaches from a fan rotor in case of a blade-off event. The liners may also be designed to protect the fan case and the gas turbine engine from an impact of any foreign objects that may be accidentally drawn into the gas turbine engine by absorbing the energy of impact.

In some embodiments, the step of adhesively bonding the at least one liner to the inner surface of the fan case barrel further includes adhesively bonding each of the plurality of liners to the inner surface of the fan case barrel by the corresponding adhesive layer.

The plurality of liners adhesively bonded at the inner surface of the fan case barrel may prevent damage to the fan case in examples wherein one or more fan blades of the gas turbine engine detaches from a fan rotor in case of a blade-off event while the gas turbine engine is operating. The liners may also be designed to protect the fan case and the gas turbine engine from the impact of any foreign objects that may be accidentally drawn into the gas turbine engine by absorbing the energy of impact. Moreover, the plurality of liners adhesively bonded at the inner surface of the fan case barrel may ensure that the each of the plurality of liners is in an intact position while the gas turbine engine is operating at extreme conditions, such as high operating temperatures, without compromising the operational efficiency of the gas turbine engine.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed). The gearbox may be a reduction gearbox (in that the output to the fan is a lower rotational rate than the input from the core shaft). Any type of gearbox may be used.

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. The bypass duct may be substantially annular. The bypass duct may be radially outside the engine core. The radially outer surface of the bypass duct may be defined by a nacelle and/or the fan case.

Specific thrust of an engine may be defined as the net thrust of the engine divided by the total mass flow through the engine. At cruise conditions, the specific thrust of an engine described and/or claimed herein may be less than (or in the order of) any of the following: 110 Nkg-1s, 105 Nkg-1s, 100 Nkg-1s, 95 Nkg-1s, 90 Nkg-1s, 85 Nkg-1s or 80 Nkg-1s. The specific thrust may be in an inclusive range bounded by any two of the values in the previous sentence (i.e., the values may form upper or lower bounds), for example in the range of from 80 Nkg-1s to 100 Nkg-1s, or 85 Nkg-1s to 95 Nkg-1s. Such engines may be particularly efficient in comparison with conventional gas turbine engines.

A fan blade and/or aerofoil portion of a fan blade described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fibre.

The fan of a gas turbine as described and/or claimed herein may have any desired number of fan blades, for example 14, 16, 18, 20, 22, 24 or 26 fan blades.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a schematic side view of a gas turbine engine;

FIG. 2 is a schematic perspective view illustrating a fan case of the gas turbine engine of FIG. 1;

FIG. 3 is a schematic perspective view illustrating a liner of the fan case of FIG. 2;

FIG. 4 is a schematic cross-sectional view of a system for assembling the fan case of FIG. 2, according to an embodiment of the present disclosure;

FIG. 5 is a functional block diagram of the system of FIG. 4 including at least one temperature sensor, a controller, and a heat source;

FIG. 6 is a schematic view of a form of the heat source of FIG. 5;

FIG. 7 is a schematic view of another form of the heat source of FIG. 5;

FIG. 8 is a schematic view of yet another form of the heat source of FIG. 5;

FIG. 9 is a schematic view of a further form of the heat source of FIG. 5; and

FIG. 10 is a flowchart for a method for assembling the fan case of FIG. 2, according to an embodiment of the present disclosure.

### DETAILED DESCRIPTION

Aspects and embodiments of the present disclosure will now be discussed with reference to the accompanying figures. Further aspects and embodiments will be apparent to those skilled in the art.

As used herein, the term “configured to” and like is at least as restrictive as the term “adapted to” and requires actual design intention to perform the specified function rather than mere physical capability of performing such a function.

As used herein, the terms “first”, “second”, and “third” are used as identifiers. Therefore, such terms should not be construed as limiting of this disclosure. The terms “first”, “second” and “third”, when used in conjunction with a feature or an element can be interchanged throughout the embodiments of this disclosure.

As used herein, “at least one of A and B” should be understood to mean “only A, only B, or both A and B”.

As used herein, the term “partially” refers to any percentage greater than 1%. In other words, the term “partially” refers to any amount of a whole. For example, “partially” may refer to a small portion, half, or a selected portion of a whole. In some cases, “partially” may refer to a whole amount. The term “partially” refers to any percentage less than 100%.

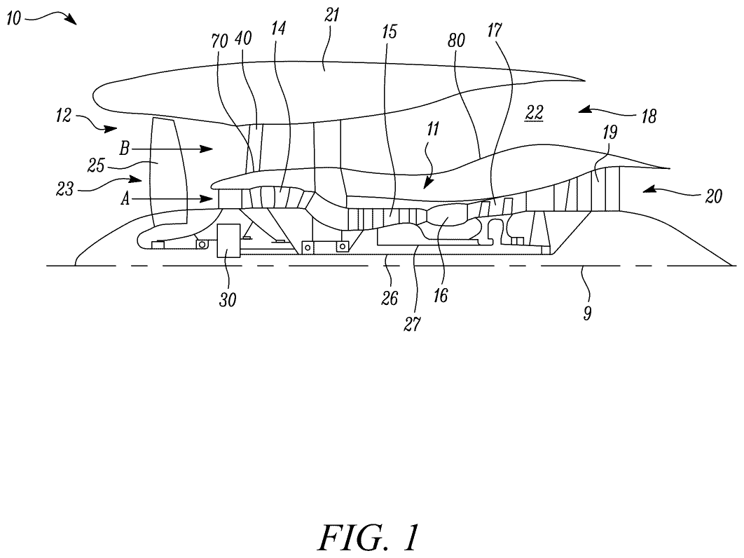

FIG. 1 is a schematic side view of a gas turbine engine 10 having a principal rotational axis 9. The gas turbine engine 10 comprises an air intake 12 and a fan 23 that generates two airflows: a core airflow A and a bypass airflow B. The gas turbine engine 10 comprises an engine core 11 that receives the core airflow A. In other words, the core airflow A enters the engine core 11. The fan 23 is located upstream of the engine core 11. The fan 23 includes a plurality of blades 25 (only one is shown herein for illustrative purposes) that upon rotating, generates the core airflow A and the bypass airflow B.

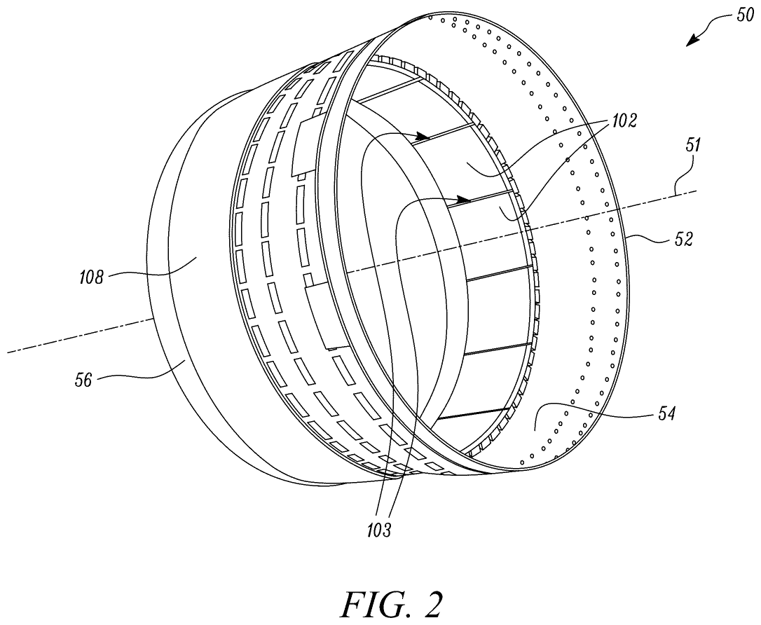

The engine core 11 comprises, in axial flow series, a compressor, a combustor, and a turbine. Specifically, the engine core 11 comprises, in axial flow series, a low pressure compressor 14, a high pressure compressor 15, a combustor 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22 surrounding the engine core 11. The bypass airflow B flows through the bypass duct 22 to provide propulsive thrust, where it is straightened by a row of outer guide vanes 40 before exiting the bypass exhaust nozzle 18. The outer guide vanes 40 extend radially outwardly from an inner ring 70 which defines a radially inner surface of the bypass duct 22. Rearward of the outer guide vanes 40, the engine core 11 is surrounded by an inner cowl 80 which provides an aerodynamic fairing defining an inner surface of the bypass duct 22. The inner cowl 80 is rearwards of and axially spaced from the inner ring 70. A fan case 50 (shown in FIG. 2) defines an outer surface of the bypass duct 22. The inner ring 70 defines the inner surface of the bypass duct 22 towards the rear of the fan case 50. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustor 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. A core shaft 27 connects the turbine 17, 19 to the compressor 14, 15. Specifically, the high pressure turbine 17 drives the high pressure compressor 15 by the suitable core shaft 27 or an interconnecting shaft. The fan 23 generally provides the majority of the propulsive thrust. The epicyclic gearbox 30 is a reduction gearbox.

FIG. 2 is a schematic perspective view of the fan case 50 of the gas turbine engine 10 (see FIG. 1), according to an embodiment of the present disclosure. As shown in FIG. 2, the fan case 50 includes a central axis 51. The fan case 50 includes a fan case barrel 52 that extends axially and circumferentially along the central axis 51. The central axis 51 may be aligned with the principal rotational axis 9 (see FIG. 1). The fan case barrel 52 may be made of a carbon fiber composite, for example. The fan case barrel 52 includes an inner surface 54 and an outer surface 56 radially opposite to the inner surface 54. The inner surface 54 of the fan case barrel faces the fan blades 25 (see FIG. 1).

The inner surface 54 of the fan case barrel 52 is coupled with a plurality of liners 102. During a blade-off event, a portion of one or more fan blades 25 or one or more complete fan blades 25 may detach from the fan 23 (see FIG. 1). In other examples, foreign objects, e.g., ice or birds may be accidentally drawn into the gas turbine engine 10 and may come in contact with the fan case barrel 52.

In such events, the liners 102 may absorb impact to prevent damage to the fan case barrel 52. Further, the liner 102 may also improve a safety of the gas turbine engine 10 and may maintain an operational efficiency of the gas turbine engine 10.

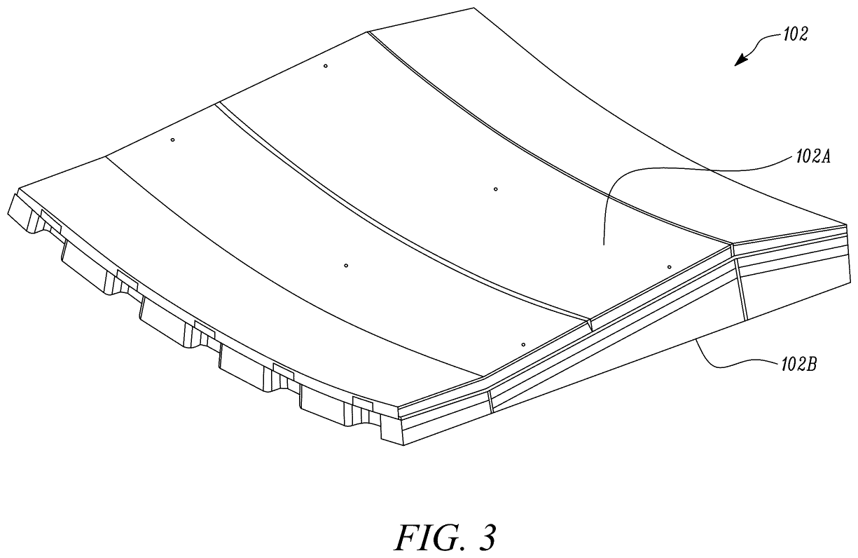

FIG. 3 is a schematic perspective view of the single liner 102 associated with the fan case 50 (see FIG. 2), according to an embodiment of the present disclosure. As shown in FIG. 3, the liner 102 includes a first major surface 102A and a second major surface 102B. It should be noted that the liner 102 may include a plurality of layers (not numbered herein) between the first major surface 102A and the second major surface 102B that together define the liner 102. For example, the liner 102 may include an abradable layer, an adhesive layer, an insulation layer, and/or a base layer, without any limitations.

In some embodiments, the at least one liner 102 is made of a metal, a composite material, or a combination thereof. The liner 102 made of a metal, a composite material, or a combination of both may absorb an energy of impact in case of the blade-off event or during entry of foreign objects during operation of the gas turbine engine 10 (see FIG. 1). Thus, the liner 102 may maintain a structural integrity of the fan case 50. The material of the liner 102 may also be chosen so as to withstand extreme operating conditions (e.g., high operating temperatures) of the gas turbine engine 10.

In some embodiments, the metal of the at least one liner 102 is titanium, aluminium, or a combination thereof. The liner 102 may absorb the energy of the impact of a separated portion or a complete fan blade 25 (see FIG. 1) in case of the blade-off event or during impact with foreign objects and may and may maintain the structural integrity of the fan case 50. The liner 102 may also withstand extreme operating conditions (e.g., high operating temperatures) of the gas turbine engine 10. It should be noted that the present disclosure is not limited to a design or a material of the liner 102. Further, the liner 102 may be manufactured by techniques such as, but not limited to, casting and molding.

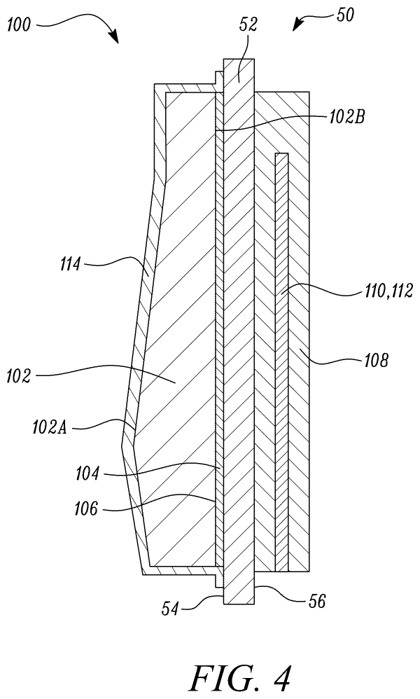

FIG. 4 is a schematic cross-sectional view of a system 100 for assembling the fan case 50 of the gas turbine engine 10 (see FIG. 1), according to an embodiment of the present disclosure. Referring now to FIGS. 2 and 4, the system 100 includes at least one adhesive layer 104 disposed on the inner surface 54 of the fan case barrel 52 of the fan case 50. The at least one adhesive layer 104 includes an inwardly facing surface 106 that is radially spaced apart from the inner surface 54 of the fan case barrel 52. In some embodiments, the at least one adhesive layer 104 includes a structural adhesive film. The structural adhesive film may improve an adhesive bond between the liner 102 and the fan case barrel 52, thereby, improving a service life, a durability, and a functionality of the liner 102.

In an example, the at least one adhesive layer 104 may include a 3M™ Scotch-Weld™ AF 3109-2 structural adhesive film from the 3M Company. In some examples, the adhesive layer 104 may include a high bonding adhesive. In an example, the adhesive layer 104 may include epoxy, without any limitations.

The system 100 further includes the at least one liner 102 disposed on the inwardly facing surface 106 of the at least one adhesive layer 104. The second major surface 102B of the liner 102 is adjacent to the inwardly facing surface 106 of the at least one adhesive layer 104.

In some embodiments, the at least one adhesive layer 104 includes a plurality of adhesive layers 104 that are circumferentially spaced apart from each other. The at least one liner 102 includes a plurality of liners 102 corresponding to the plurality of adhesive layers 104. A total number of the liners 102 corresponds to a total number of the adhesive layers 104. Moreover, the plurality of liners 102 are circumferentially spaced apart from each other. Further, a gap 103 is present between each liner 102 and an adjacent liner 102.

Each of the plurality of liners 102 is disposed on the inwardly facing surface 106 of a corresponding adhesive layer 104 from the plurality of adhesive layers 104. Each of the plurality of liners 102 is adhesively bonded to the inner surface 54 of the fan case barrel 52 by the corresponding adhesive layer 104. In other words, the adhesive layer 104 may be disposed between each of the plurality of liners 102 and the inner surface 54 of the fan case barrel 52. The adhesive layer 104 may bond each of the plurality of liners 102 to the inner surface 54 of the fan case barrel 52 on heating and curing.

Thus, each of the plurality of liners 102 may be adhesively bonded to the inner surface 54 of the fan case barrel 52 and are circumferentially spaced apart from each other. This may ensure that the each of the plurality of liners 102 is intact in position with respect to the corresponding adhesive layer 104 while the gas turbine engine 10 (see FIG. 1) is operating at extreme conditions, such as high operating temperatures, without compromising the operational efficiency of the gas turbine engine 10. The plurality of liners 102 adhesively bonded at the inner surface 54 of the fan case 50 may prevent damage to the fan case 50 in examples wherein one or more fan blades 25 (see FIG. 1) detaches from a fan rotor (not shown herein) in case of the blade-off event while the gas turbine engine 10 is operating. The liners 102 may also be designed to protect the fan case 50 and the gas turbine engine 10 from an impact of any foreign objects, e.g., ice or birds that may be accidentally drawn into the gas turbine engine 10, by absorbing the energy of impact.

As shown in FIG. 4, the system 100 further includes an annular structure 108 adapted to be disposed on the outer surface 56 of the fan case barrel 52. The system 100 further includes a heat source 110 coupled to the annular structure 108. The heat source 110 is adapted to heat the annular structure 108 to at least a predetermined curing temperature T1, such that the annular structure 108 inductively heats the at least one adhesive layer 104. Upon being inductively heated by the annular structure 108, the at least one adhesive layer 104 is cured, thereby adhesively bonding the at least one liner 102 to the inner surface 54 of the fan case barrel 52. The term “predetermined curing temperature” as used in this disclosure may relate to a temperature required for the adhesive layer 104 to cure in order to adhesively bond the liner 102 to the fan case barrel 52.

The system 100 may be used to couple the liner 102 to the fan case barrel 52. Specifically, the system 100 uses the heat source 110 that is coupled to the annular structure 108 to heat the at least one adhesive layer 104. Subsequently, the at least one adhesive layer 104 is cured in order to adhesively bond the at least one liner 102 to the inner surface 54 of the fan case barrel 52. Incorporation of the heat source 110 may eliminate a requirement of heating the entire fan case barrel 52 to cure the adhesive layer 104, which may reduce manufacturing costs as compared to a conventional autoclave/oven curing solution. Further, the system 100 may provide faster curing cycles by heating the at least one adhesive layer 104 and subsequently curing the adhesive layer 104. The system 100 may enable lower energy consumption, thereby providing a sustainable assembly solution. The system 100 may further enable the adhesive layer 104 to achieve a desired cure ramp rate in order to meet desired material specification requirements.

In some embodiments, the annular structure 108 includes a composite material or a metallic material. The annular structure 108 including the composite material or the metallic material may allow sufficient inductive heating of the adhesive layer 104 to achieve at least the predetermined curing temperature T1 for curing the adhesive layer 104.

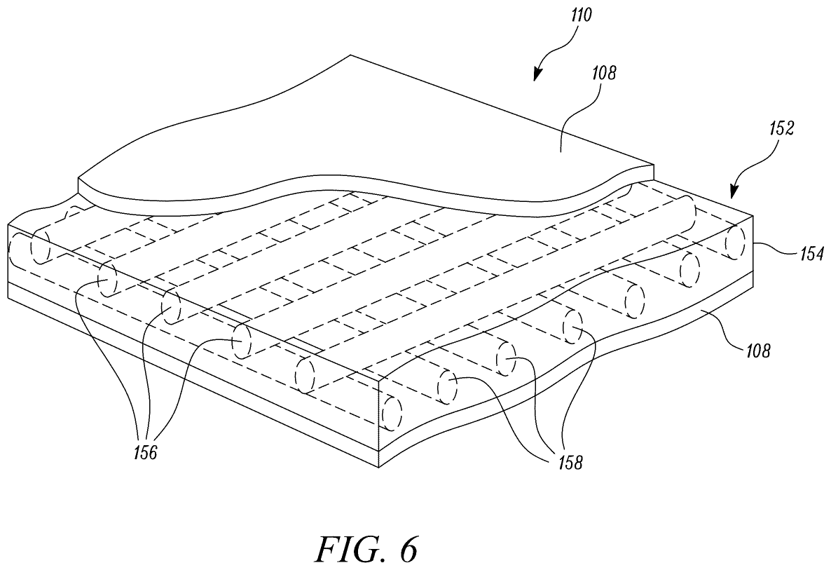

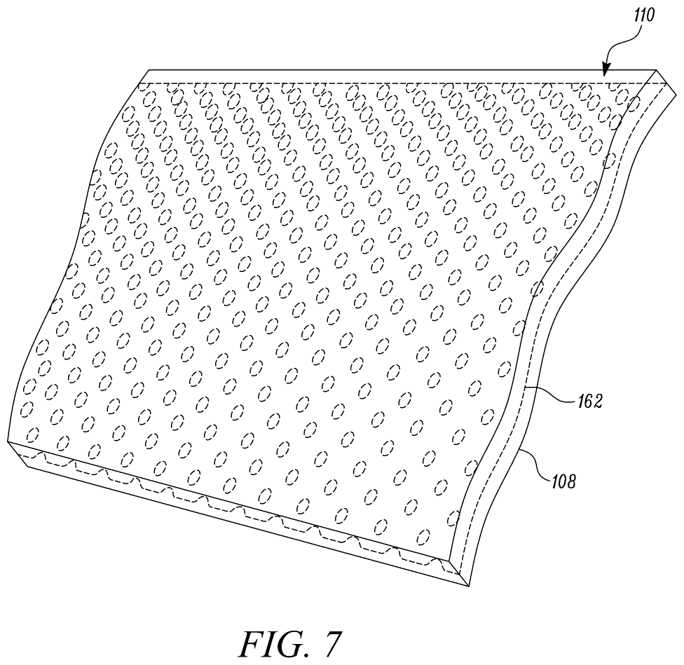

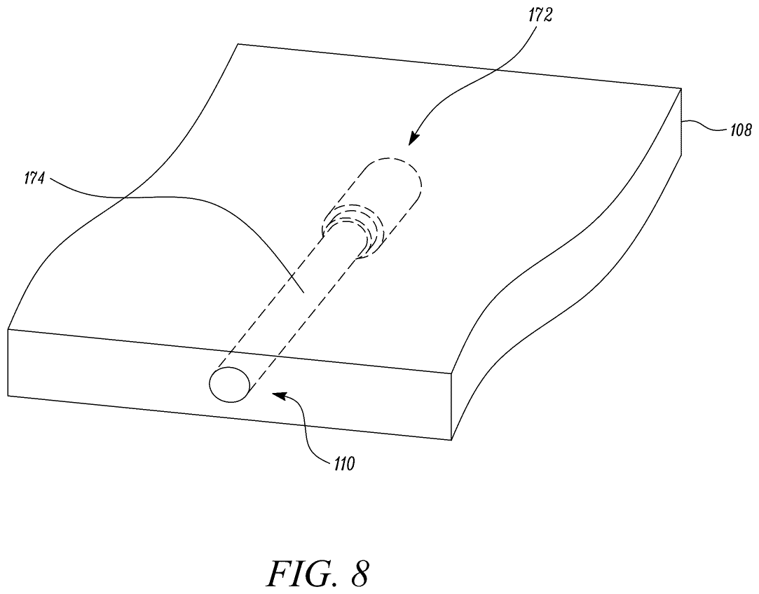

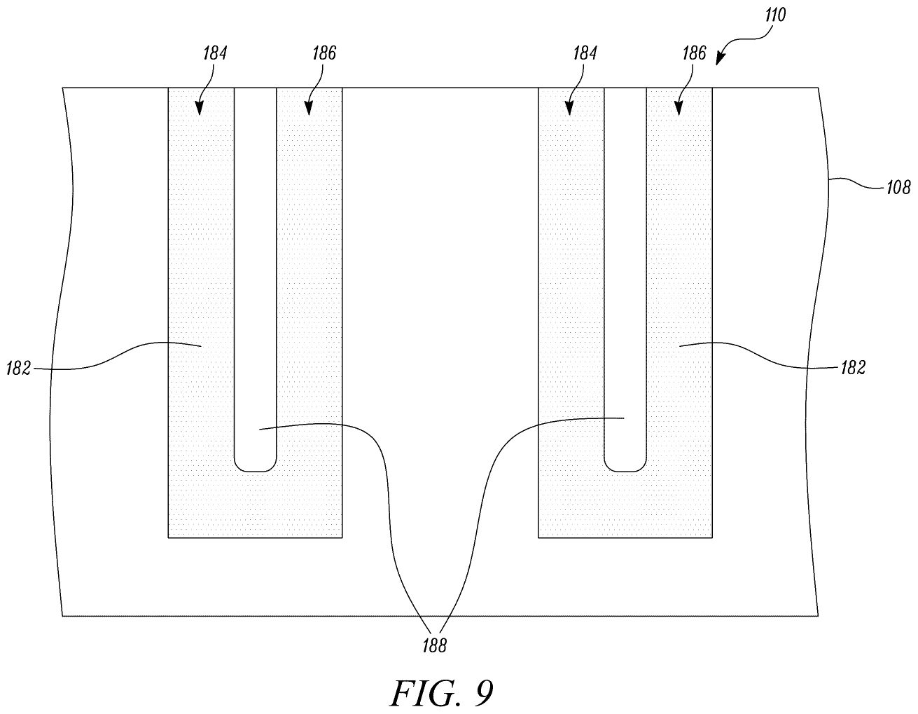

In some embodiments, the heat source 110 is at least partially embedded within the annular structure 108. In some embodiments, the heat source 110 includes an electric cartridge 152 (shown in FIG. 6), a heated fabric 162 (shown in FIG. 7), a heated film 112, a ceramic heater, an induction heater 172 (shown in FIG. 8), or a heated fluid 182 (shown in FIG. 9).

In the illustrated embodiment of FIG. 4, the heat source 110 includes the heated film 112 that is adapted to heat the annular structure 108. The heated film 112 may be embedded in the annular structure 108 and may heat the annular structure 108. The annular structure 108 may inductively heat the adhesive layer 104 thereby allowing the adhesive layer 104 to attain at least the predetermined curing temperature T1. The heated film 112 may be a metallic film, a composite heated film, and the like. The heated film 112 may include heated filler materials in a matrix.

The heat source 110 including the electric cartridge 152, the heated fabric 162, the heated film 112, the ceramic heater, the induction heater 172, or the heated fluid 182 may enable the heat source 110 to heat only the desired area of the fan case barrel 52 instead of heating the entire fan case 50, thereby preventing high energy consumption. The heat source 110 may provide a stand-alone curing solution that may eliminate use of the autoclave or the oven to cure the adhesive layer 104 to couple the liner 102 to the fan case barrel 52. Further, the heat source 110 may provide a portable solution for service and maintenance during replacement of the liner 102.

Different types of the heat source 110 may be used in the system 100 as per requirements. For example, different types of the heat source 110 may be used for different working conditions, applications, and materials associated with the fan case 50. However, the heat source 110 that is coupled to the annular structure 108 may be similar in terms of functionality. The different types of heat sources 110 will be discussed in greater details later in this section with reference to FIGS. 6 to 9.

In some embodiments, the system 100 further includes an insulation layer 114 covering each of the at least one liner 102 and the at least one adhesive layer 104. The insulation layer 114 may be at least partially disposed on the fan case barrel 52. In the illustrated embodiment of FIG. 4, the insulation layer 114 is disposed adjacent to the first major surface 102A of the liner 102. The insulation layer 114 may minimize heat dissipation and may retain at least the predetermined curing temperature T1 localized at the at least one adhesive layer 104. Moreover, the insulation layer 114 may also prevent damage to the fan case barrel 52 and the liner 102 due to overheating.

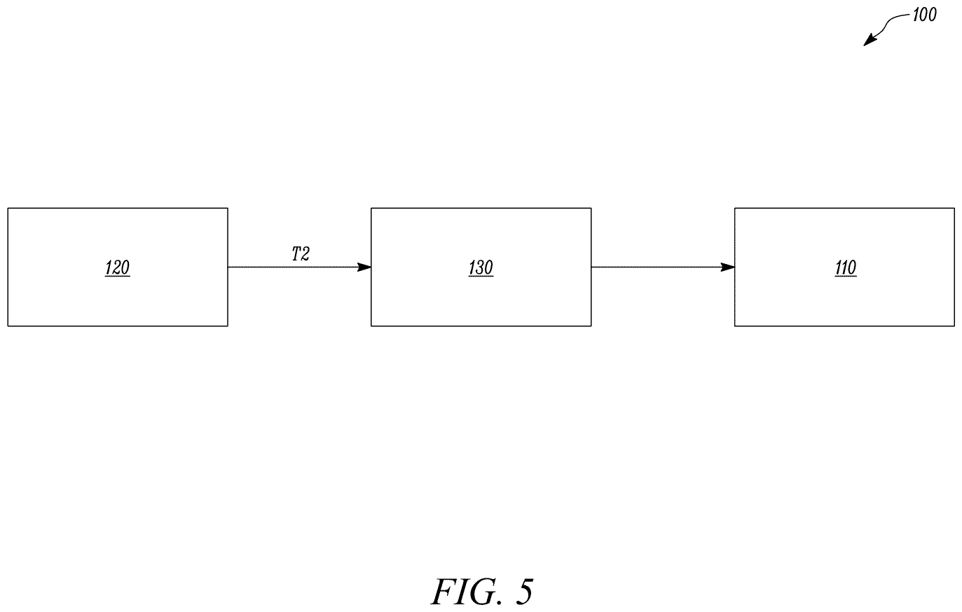

FIG. 5 is a functional block diagram of the system 100 including at least one temperature sensor 120, a controller 130, and the heat source 110, according to an embodiment of the present disclosure.

Referring to FIGS. 4 and 5, the system 100 includes the controller 130 that is communicably coupled to the heat source 110. The controller 130 is configured to control the heat source 110 to heat the annular structure 108 to at least the predetermined curing temperature T1. Controlling of the heat source 110 may prevent overheating of the annular structure 108 by the heat source 110, thereby preventing damage of the annular structure 108. Further, controlling of the heat source 110 may enable the adhesive layer 104 to achieve the desired cure ramp rate to meet desired material specification requirements. In some examples, the controller 130 may be a control circuit, a computer, a microprocessor, a microcomputer, a central processing unit, or any suitable device or apparatus.

The system 100 further includes the at least one temperature sensor 120 that is disposed proximal to the inner surface 54 of the fan case barrel 52 to measure a temperature T2 proximal to the inner surface 54 of the fan case barrel 52. The at least one temperature sensor 120 is communicably coupled to the controller 130. The controller 130 is configured to control the heat source 110, so that the temperature T2 proximal to the inner surface 54 of the fan case barrel 52 is equal to at least the predetermined curing temperature T1. Although only one temperature sensor 120 is illustrated herein, the system 100 may include multiple temperature sensors. For example, two or more temperature sensors may be associated with each liner 102.

The at least one temperature sensor 120 may measure the temperature T2 proximal to the inner surface 54 of the fan case barrel 52 and may communicate a value of the temperature T2 to the controller 130. Further, based on the value of the temperature T2 received form the temperature sensor 120, the controller 130 may control the heat source 110 to ensure that the annular structure 108 may attain at least the predetermined curing temperature T1, without overheating or causing damage to the liner 102, the fan case barrel 52, and/or the adhesive layer 104. In some examples, the controller 130 may heat the annular structure 108 to a temperature that is greater than the predetermined curing temperature T1 required for curing the adhesive layer 104, as some heat loss may be possible.

The controller 130 and the temperature sensor 120 may together ensure that the temperature T2 proximal to the inner surface 54 of the fan case barrel 52 is sufficient to facilitate curing of the adhesive layer 104, without causing any damage to the annular structure 108, the liner 102, and/or the adhesive layer 104 due to overheating.

Referring again to FIG. 4, the system 100 may enable the adhesive layer 104 to achieve the desired cure ramp rate which may improve an adhesive bond between the adhesive layer 104 and the corresponding liner 102. Further, as the desired cure ramp rate is achieved, an adhesive bond between the adhesive layer 104 and the inner surface 54 of the fan case barrel 52 may also be improved. Furthermore, the at least adhesive layer 104 cured by the system 100 may be of high quality, and may be compliant with profile tolerances, surface tolerances, adhesive thickness, and porosity requirements. In some embodiments, the adhesive layer 104 may have a uniform thickness. The liners 102 bonded using the system 100 may exhibit improved quality and durability.

FIG. 6 is a schematic view of the heat source 110, according to an embodiment of the present disclosure. In the illustrated embodiment of FIG. 6, the heat source 110 includes the electric cartridge 152 adapted to heat the adhesive layer 104 (see FIG. 4). The electric cartridge 152 may be embedded within the annular structure 108. Only a portion of the annular structure 108 and the electric cartridge 152 is illustrated herein for exemplary purposes. The electric cartridge 152 may include a casing 154. The electric cartridge 152 may further include one or more first heat pipes 156 and one or more second heat pipes 158 disposed orthogonal to the one or more first heat pipes 156. Each of the first and second heat pipes 156, 158 may be disposed within the casing 154. The first and second heat pipes 156, 158 may generate heat when a voltage is applied to the first heat pipes 156 and/or the second heat pipes 158. The heat generated by the electric cartridge 152 may heat and cure the adhesive layer 104.

FIG. 7 is a schematic view of the heat source 110, according to another embodiment of the present disclosure. In the illustrated embodiment of FIG. 7, the heat source 110 includes the heated fabric 162 adapted to heat the adhesive layer 104 (see FIG. 4). The heated fabric 162 may be embedded within the annular structure 108. Only a portion of the annular structure 108 and the heated fabric 162 is illustrated herein for exemplary purposes. The heated fabric 162 may include non-metallic porous or perforated fabric heating elements. In some examples, the heating elements may be in the form of conductive yarns, filaments, fibers, wires, and the like. The heated fabric 162 may generate heat when a voltage is applied to the heating elements. The heat generated by the heated fabric 162 may heat and cure the adhesive layer 104.

FIG. 8 is a schematic view of the heat source 110, according to yet another embodiment of the present disclosure. In the illustrated embodiment FIG. 8, the heat source 110 includes the induction heater 172 adapted to heat the adhesive layer 104 (see FIG. 4). The induction heater 172 may be at least partially embedded within the annular structure 108. Only a portion of the annular structure 108 and the induction heater 172 is illustrated herein for exemplary purposes. The induction heater 172 includes an inductor 174. In some examples, the inductor 174 may be a copper inductor. In other examples, the inductor 174 may be made of any other material that conducts heat and electricity. Induction heating may be achieved by applying a high-frequency current to the inductor 174, thereby generating a magnetic field around the inductor 174. The magnetic field induces eddy currents in a circular path in the annular structure 108, thereby generating heat. The heat generated by the induction heater 172 may heat and cure the adhesive layer 104.

FIG. 9 is a schematic view of the heat source 110, according to yet another embodiment of the present disclosure. In the illustrated embodiment FIG. 9, the heat source 110 includes the heated fluid 182 that flows through the annular structure 108. The heated fluid 182 is adapted to cure the adhesive layer 104 (see FIG. 4). For example, compressed air may be used as the heated fluid 182. The annular structure 108 may define at least one inlet flow channel 184 and at least one outlet flow channel 186 separated by a divider 188. As an example, two inlet flow channels 184 and two outlet flow channels 186 are illustrated herein. However, multiple such inlet and outlet flow channels 184, 186 may be defined within the annular structure 108 separated by corresponding dividers 188. The heated fluid 182 may enter the annular structure 108 via the inlet flow channels 184 and may exit the annular structure 108 via the outlet flow channels 186. The heated fluid 182 may generate heat to cure the adhesive layer 104 while flowing through the annular structure 108. Alternatively, flow conduits may be disposed within the annular structure 108 to define channels through which the heated fluid 182 may flow.

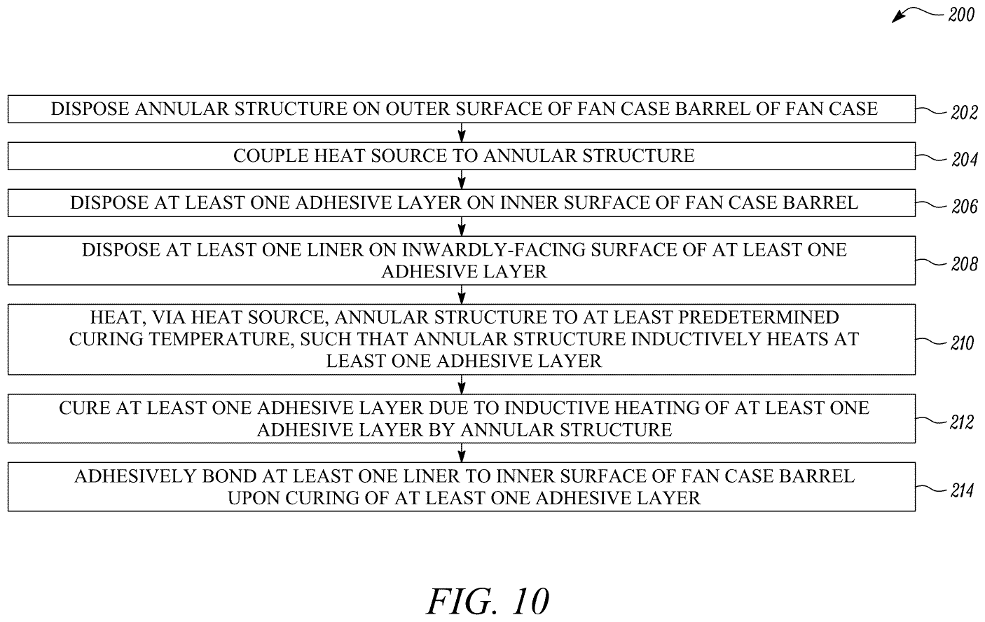

FIG. 10 is a flowchart for a method 200 for assembling the fan case 50 of the gas turbine engine 10, according to an embodiment of the present disclosure.

With reference to FIGS. 1 to 5 and FIG. 10, at step 202, the annular structure 108 is disposed on the outer surface 56 of the fan case barrel 52 of the fan case 50. At step 204, the heat source 110 is coupled to the annular structure 108. At step 206, the at least one adhesive layer 104 is disposed on the inner surface 54 of the fan case barrel 52.

At step 208, the at least one liner 102 is disposed on the inwardly-facing surface 106 of the at least one adhesive layer 104. The inwardly-facing surface 106 of the at least one adhesive layer 104 is radially spaced apart from the inner surface 54 of the fan case barrel 52. In some embodiments, the at least one adhesive layer 104 includes the plurality of adhesive layers 104 that are circumferentially spaced apart from each other. In some embodiments, the at least one liner 102 includes the plurality of liners 102 corresponding to the plurality of adhesive layers 104. The plurality of liners 102 are circumferentially spaced apart from each other. The step 208 of disposing the at least one liner 102 on the inwardly-facing surface 106 of the at least one adhesive layer 104 further includes disposing each of the plurality of liners 102 on the inwardly-facing surface 106 of the corresponding adhesive layer 104 from the plurality of adhesive layers 104.

At step 210, the annular structure 108 is heated by the heat source 110 to at least the predetermined curing temperature T1, such that the annular structure 108 inductively heats the at least one adhesive layer 104.

At step 212, the at least one adhesive layer 104 is cured due to the inductive heating of the at least one adhesive layer 104 by the annular structure 108.

At step 214, the at least one liner 102 is adhesively bonded to the inner surface 54 of the fan case barrel 52 upon curing of the at least one adhesive layer 104. In some embodiments, the step 214 of adhesively bonding the at least one liner 102 to the inner surface 54 of the fan case barrel 52 further includes adhesively bonding each of the plurality of liners 102 to the inner surface 54 of the fan case barrel 52 by the corresponding adhesive layer 104.

In some embodiments, the method 200 further includes a step of disposing the insulation layer 114 covering each of the at least one liner 102 and the at least one adhesive layer 104.

In some embodiments, the method 200 further includes a step of controlling, via the controller 130 that is communicably coupled to the heat source 110, the heat source 110 to heat the annular structure 108 to at least the predetermined curing temperature T1.

In some embodiments, the method 200 further includes a step of measuring, via the at least one temperature sensor 120 disposed proximal to the inner surface 54 of the fan case barrel 52, the temperature T2 proximal to the inner surface 54 of the fan case barrel 52. The at least one temperature sensor 120 is communicably coupled to the controller 130. The method 200 further includes a step of controlling, via the controller 130, the heat source 110, so that the temperature T2 proximal to the inner surface 54 of the fan case barrel 52 is equal to at least the predetermined curing temperature T1.

It should be noted that, during actual implementation, an order in which the steps of the method 200 are performed may vary from what is explained above and illustrated in FIG. 10, as per requirements. Moreover, multiple steps may be performed together.

Further, the gas turbine engine 10 includes the fan case 50 that is assembled by the method 200 explained above. The fan case 50 may be assembled in a cost-effective manner and may have a longer service life due to the liners 102 adhesively bonded at the inner surface 54 of the fan case barrel 52.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A system for assembling a fan case of a gas turbine engine, the system comprising:
at least one adhesive layer disposed on an inner surface of a fan case barrel of the fan case, wherein the at least one adhesive layer includes an inwardly-facing surface that is radially spaced apart from the inner surface of the fan case barrel;
at least one liner disposed on the inwardly-facing surface of the at least one adhesive layer;
an annular structure adapted to be disposed on an outer surface of the fan case barrel;
a heat source coupled to the annular structure, wherein the heat source is adapted to heat the annular structure to at least a predetermined curing temperature, such that the annular structure inductively heats the at least one adhesive layer, and wherein, upon being inductively heated by the annular structure, the at least one adhesive layer is cured, thereby adhesively bonding the at least one liner to the inner surface of the fan case barrel;
a controller that is communicably coupled to the heat source, wherein the controller is configured to control the heat source to heat the annular structure to at least the predetermined curing temperature; and
at least one temperature sensor that is disposed proximal to the inner surface of the fan case barrel to measure a temperature proximal to the inner surface of the fan case barrel, wherein the at least one temperature sensor is communicably coupled to the controller, and wherein the controller is configured to control the heat source, so that the temperature proximal to the inner surface of the fan case barrel is equal to at least the predetermined curing temperature.

2. The system of claim 1, further comprising an insulation layer covering each of the at least one liner and the at least one adhesive layer.

3. The system of claim 1, wherein the at least one adhesive layer includes a plurality of adhesive layers that are circumferentially spaced apart from each other, wherein the at least one liner includes a plurality of liners corresponding to the plurality of adhesive layers, wherein the plurality of liners are circumferentially spaced apart from each other, wherein each of the plurality of liners is disposed on the inwardly-facing surface of a corresponding adhesive layer from the plurality of adhesive layers, and wherein each of the plurality of liners is adhesively bonded to the inner surface of the fan case barrel by the corresponding adhesive layer.

4. The system of claim 1, wherein the annular structure includes a composite material or a metallic material.

5. The system of claim 1, wherein the heat source is at least partially embedded within the annular structure.

6. The system of claim 1, wherein the heat source includes an electric cartridge, a heated fabric, a heated film, a ceramic heater, an induction heater, or a heated fluid.

7. The system of claim 1, wherein the at least one liner is made of a metal, a composite material, or a combination thereof.

8. The system of claim 7, wherein the metal of the at least one liner is titanium, aluminium, or a combination thereof.

9. The system of claim 1, wherein the at least one adhesive layer includes a structural adhesive film.

10. A method for assembling a fan case of a gas turbine engine, the method comprising the steps of:
disposing an annular structure on an outer surface of a fan case barrel of the fan case;
coupling a heat source to the annular structure;
disposing at least one adhesive layer on an inner surface of the fan case barrel;
disposing at least one liner on an inwardly-facing surface of the at least one adhesive layer, wherein the inwardly-facing surface of the at least one adhesive layer is radially spaced apart from the inner surface of the fan case barrel;
heating, via the heat source, the annular structure to at least a predetermined curing temperature, such that the annular structure inductively heats the at least one adhesive layer;
controlling, via a controller that is communicably coupled to the heat source, the heat source to heat the annular structure to at least the predetermined curing temperature;
measuring, via at least one temperature sensor disposed proximal to the inner surface of the fan case barrel, a temperature proximal to the inner surface of the fan case barrel, wherein the at least one temperature sensor is communicably coupled to the controller;
controlling via the controller, the heat source, so that the temperature proximal to the inner surface of the fan case barrel is equal to at least the predetermined curing temperature;
curing the at least one adhesive layer due to the inductive heating of the at least one adhesive layer by the annular structure; and
adhesively bonding the at least one liner to the inner surface of the fan case barrel upon curing of the at least one adhesive layer.

11. The method of claim 10, further comprising disposing an insulation layer covering each of the at least one liner and the at least one adhesive layer.

12. The method of claim 10, wherein the at least one adhesive layer includes a plurality of adhesive layers that are circumferentially spaced apart from each other, wherein the at least one liner includes a plurality of liners corresponding to the plurality of adhesive layers, wherein the plurality of liners are circumferentially spaced apart from each other, and wherein the step of disposing the at least one liner on the inwardly-facing surface of the at least one adhesive layer further includes disposing each of the plurality of liners on the inwardly-facing surface of a corresponding adhesive layer from the plurality of adhesive layers.

13. The method of claim 12, wherein the step of adhesively bonding the at least one liner to the inner surface of the fan case barrel further includes adhesively bonding each of the plurality of liners to the inner surface of the fan case barrel by the corresponding adhesive layer.
